(19) United States
(12) Patent Application Publication
(10) Pub. No.: US 2026/0157339 A1
(43) Pub. Date: Jun. 11, 2026

(54) CAT LITTER BOX

(71) Applicant: UBTECH ROBOTICS CORP LTD, Shenzhen (CN)

(72) Inventors: Fan Yang, Shenzhen (CN); Yudong Liu, Shenzhen (CN); Xinshui Huang, Shenzhen (CN); Mingming Ji, Shenzhen (CN); Jin Li, Shenzhen (CN)

(21) Appl. No.: 19/537,502

(22) Filed: Feb. 12, 2026

Related U.S. Application Data
(63) Continuation of application No. PCT/CN2024/089518, filed on Apr. 24, 2024.

(30) Foreign Application Priority Data
Apr. 22, 2024 (CN) 202410482585.9

(51) Int. Cl. A01K 1/01

(52) U.S. Cl. CPC A01K 1/0114

(57) ABSTRACT

A cat litter box includes a base, a driver, and a drum assembly. The driver drives the drum assembly to rotate. The drum assembly includes a drum body and a partition assembly. The partition assembly includes a partition plate, a little guide plate, a litter sieve, and an emptying plate. The partition assembly divides an accommodating cavity into a first cavity and a second cavity. The first cavity is configured to accommodate a pet. A waste collecting compartment and a little collecting compartment are defined in the second cavity. The litter sieve is a litter inlet of the little collecting compartment. The little guide plate is movable relative to the partition plate to communicate the first cavity with the waste collecting compartment. The little guide plate is a door of an waste inlet of the waste collecting compartment. The emptying plate is configured to cover the litter sieve.

### CROSS REFERENCE TO RELATED APPLICATIONS

The present disclosure is a continuation-application of International Application PCT/CN 2024/089518, with an international filing date of Apr. 24, 2024, which claims foreign priority of Chinese Patent Application No. 202410482585.9, filed on Apr. 22, 2024 in the State Intellectual Property Office of China, the contents of all of which are hereby incorporated by reference.

### TECHNICAL FIELD

The present disclosure relates to a technical field of smart home, and in particular to a cat litter box.

### BACKGROUND

As people's living standards continue to improve, more and more people are paying attention to their spiritual lives, and keeping pets has become one of ways for many to add fun to their lives. Cats, with their independent personalities and adorable appearance, become a top choice among many pets. While keeping the cats indeed brings companionship and satisfaction to cat owners, it also comes with some daily care hassles, especially cleaning cat feces every day, which causes considerable trouble for many cat owners.

Conventional cat faces cleaning mainly relies on manual operation. Specifically, after a cat defecates in a cat litter box, a cat owner needs to manually scoop and remove the cat feces, which not only requires frequent close contact with the cat feces but also requires enduring the odor.

Currently, automatic cat litter boxes, which use a motor to automatically separate cat litter and the cat feces, appear on the market. The automatic cat litter boxes eliminate a need for manual scooping the cat feces and provide great convenience for the cat owners. However, the automatic cat litter boxes on the market still have some design shortcomings. Specifically, waste collecting compartments are commonly disposed at a bottom portion of the automatic cat litter boxes, resulting in an entrance for the cat to enter and exit the automatic cat litter boxes being relatively high off the ground, which is not user-friendly for smaller cats. In addition, the automatic cat litter boxes commonly have mechanical rolling clamping structures therein, which pose a certain risk of pinching injury and may threaten the safety of the cats.

### SUMMARY

A purpose of the present disclosure is to provide a cat litter box that solves technical problems of conventional cat litter boxes, such as excessively high opening that make it inconvenient for cats to enter, and rolling clamping structures inside the conventional cat litter boxes that pose a risk of pinching injury.

To realize the purpose, the present disclosure provides a cat litter box. The cat litter box comprises a base, a driver, and a drum assembly.

The drum assembly is rotatably disposed on the base and is driven to rotate by the driver. The drum assembly comprises a drum body defining an accommodating cavity and a partition assembly disposed in the drum body. The partition assembly comprises a partition plate, a little guide plate, a litter sieve, and an emptying plate. The partition plate is disposed between the little guide plate and the litter sieve. The partition plate, the little guide plate, and the litter sieve jointly divide the accommodating cavity into a first cavity and a second cavity. The first cavity is configured to accommodate a pet. A waste collecting compartment and a little collecting compartment are disposed in the second cavity. The waste collecting compartment and the little collecting compartment are spaced apart from each other. The litter sieve is configured as a litter inlet of the little collecting compartment. The little guide plate is movable relative to the partition plate to communicate the first cavity and the waste collecting compartment. The little guide plate is a door of an waste inlet of the waste collecting compartment. The emptying plate is configured to cover the litter sieve so as to isolate the first cavity and the little collecting compartment.

In the embodiment, the cat litter box comprises the base, the driver, and the drum assembly. The drum assembly comprises the drum body and the partition assembly. The partition assembly divides the accommodating cavity of the drum body into the first cavity and the second cavity. The first cavity provides a staying space for the pet, such as a cat, while the second cavity comprises the waste collecting compartment and the litter collecting compartment that are spaced apart from each other. The partition assembly comprises the partition plate, the litter guide plate, the litter sieve, and the emptying plate. The litter guide plate is configured as the waste inlet of the waste collecting compartment, and the litter sieve is configured as the door of the litter inlet of the litter collecting compartment.

When the pet defecates, cat litter is placed at a bottom portion of the first cavity. After the pet defecates, during a cleaning process, the driver rotates the drum assembly in a first direction. As the litter sieve rotates to the bottom of the first cavity, the cat litter passes through the litter sieve into the litter collecting compartment, while larger waste remains on the litter sieve, thereby separating the cat litter from the waste. After separation, the drum assembly continues to rotate, causing the waste to slide along a surface of the litter sieve and a surface of the partition plate toward the litter guide plate. The litter guide plate is then pushed open, allowing the waste to enter the waste collecting compartment. Subsequently, the driver rotates the drum assembly in a second direction to return the partition assembly to an initial position, and the cat litter falls back into the first cavity under gravity. When it is necessary to replace the cat litter, the emptying plate is positioned to cover the litter sieve. The driver then rotates the drum assembly in the first direction, causing the cat litter to slide along the surface of the emptying plate and the surface of the partition plate toward the litter guide plate. The litter guide plate is pushed open, allowing the cat litter to enter the waste collecting compartment.

In the cat litter box of the present disclosure, when the drum assembly is in the initial position, the waste collecting compartment is located on one side of the drum assembly, thereby reducing a height of the base and making it easier for the pet to enter an interior of the drum assembly. Furthermore, the partition assembly divides the accommodating cavity into the first cavity and the second cavity, and there is no rolling clamping structure inside the accommodating cavity, which avoids a risk of pinching injury of the pet. Additionally, by providing the emptying plate, the cat litter is allowed to be automatically transferred to the waste collecting compartment, eliminating a need for manual replacement of the cat litter.

Optionally, the emptying plate is detachably connected to the litter sieve.

In the embodiment, a pet owner is allowed to either attach the emptying plate to the litter sieve or remove the emptying plate, depending on different operational requirements.

Optionally, at least one hooking portion is formed on one side of the emptying plate close to the partition plate. The at least one hooking portion is configured to insert between the partition plate and the litter sieve.

In the embodiment, by providing the at least one hooking portion on the emptying plate, the emptying plate is easily installed to the litter sieve. During installation, the at least one hooking portion is simply hooked onto the litter sieve, making both attachment and removal effortless.

Optionally, at least one first engaging portion is disposed on the litter sieve. At least one second engaging portion is disposed on the emptying plate. The at least one first engaging portion is engaged with the at least one second engaging portion.

In the embodiment, by engaging the at least one first engaging portion with the at least one second engaging portion, the emptying plate is snapped onto the litter sieve, thus achieving a detachable connection between the emptying plate and the litter sieve. Moreover, no installation or disassembly tools are required when assembling or disassembling the emptying plate. That is, the emptying plate is able to be installed manually.

Optionally, one side of the litter sieve close to the partition plate is rotatably connected to the partition plate. A stop portion is disposed on one side of the drum body where the litter sieve faces the litter collecting compartment.

In the embodiment, the litter sieve is rotatably connected with the partition plate, and the stop portion is disposed on the drum body, so that the litter sieve is only allowed to rotate in a direction away from the litter collecting compartment. In this way, it ensures that during waste collection, the litter sieve remains stably positioned at an edge of the litter collecting compartment, so that litter sifting and waste collection are not affected. After waste collection, the litter sieve is manually rotated to open the litter collecting compartment, allowing the cat litter to quickly fall back into the first cavity, preventing excessive cat litter residue from remaining in the litter collecting compartment.

Optionally, a gap between the drum body and the base is less than 5 mm.

In the embodiment, by configuring the gap between the drum body and the base to less than 5 mm, a risk of the cat being pinched is reduced.

Optionally, a gravity sensor configured to detect a weight change of the drum assembly is disposed on the base.

In the embodiment, by providing the gravity sensor, it is detected whether the pet enters the drum assembly. When the pet is detected, the drum assembly is stopped to prevent the cat from being pinched.

Optionally, the drum body comprises a first drum section, a second drum section, and a cover. The first drum section has a pet entrance for the pet to enter. The cover covers an outlet of the waste collecting compartment. The partition plate extends along an inner wall of the first drum section and/or an inner wall of the second drum section to form an extension portion. The extension portion is fixed to the first drum section and/or the second drum section.

In the embodiment, the drum body is composed of the first drum section, the second drum section and the cover, so that the drum body is easy to manufacture and an installation of the partition assembly is also easy. The extension portion allows the partition assembly to fit snugly against an inner wall of the drum body, further reducing the risk of the cat being pinched, and makes it easy to install the partition assembly on the inner wall of the drum body.

Optionally, a first toothed portion is disposed on one side of the first drum section. A second toothed portion is disposed on one side of the second drum section. The first toothed portion and the second toothed portion jointly form an annular toothed structure.

In the embodiment, the annular toothed structure is assembled by the first toothed portion and the second toothed, so that machining difficulty of the annular toothed structure is reduced, thereby reducing machining cost.

Optionally, roller assemblies configured to support the drum assembly are disposed on one side of the base facing the drum assembly.

Optionally, in an initial state, the pet entrance 14 is located at a bottom portion of the drum body, and a plane where a geometric center of the pet entrance 14 lies is parallel to a rotation axis of the drum body.

In the embodiment, by providing the roller assemblies on the base, the drum assembly is supported, a rotation of the drum assembly is guided, and a friction between the base and the drum assembly is reduced. In this way, bearings are eliminated to reduce the manufacturing cost of the cat litter box.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a perspective schematic diagram of a cat litter box according to one embodiment of the present disclosure.

FIG. 2 is a partial schematic diagram of the cat litter box according to one embodiment of the present disclosure.

FIG. 3 is an exploded schematic diagram of the cat litter box according to one embodiment of the present disclosure.

FIG. 4 is a cross-sectional schematic diagram of the cat litter box according to one embodiment of the present disclosure.

FIG. 5 is a perspective schematic diagram of a partition assembly according to one embodiment of the present disclosure.

FIG. 6 is a perspective schematic diagram of a litter sieve and an emptying plate according to one embodiment of the present disclosure.

FIG. 7 is a perspective schematic diagram of a base according to one embodiment of the present disclosure.

In the drawings: 10-base; 11-roller assembly; 12-gravity sensor; 20-drum assembly; 201-first cavity; 202-second cavity; 2021-litter collecting compartment; 2022-waste collecting compartment; 203-waste inlet; 21-drum body; 211-first drum section; 212-second drum section; 213-cover; 214-annular toothed structure; 2141-first toothed portion; 2142-second toothed portion; 215-stop portion; 22-partition assembly; 221-litter sieve; 2211-rotating shaft; 222-partition plate; 2221-extension portion; 223-litter plate; 224-emptying plate; 2241-grip portion; 2242-shaft hole 2243-hooking portion; 225-dividing plate; 226-waste bin.

### DETAILED DESCRIPTION

Embodiments of the present disclosure are described in detail below. Examples of the embodiments are shown in the accompanying drawings, in which the same or similar reference numerals indicate the same or similar elements or elements with the same or similar functions. The embodiments described below with reference to the drawings are exemplary, and are intended to explain the present disclosure, but should not be regarded as a limitation to the present disclosure.

It should be noted that when an element is referred to as being “fixed to” another element, it may be directly fixed to another element or indirectly fixed to another element through intervening elements. When the element is considered to be “connected” to another element, it may be directly connected to another element or intervening elements may be present at the same time. When the element is considered to be “directly connected” to another element, there is no intervening element. The terms “vertical”, “horizontal”, “left”, “right”, and the like, as used herein, are for illustrative purposes only.

It should be noted in the description of the present disclosure that, unless otherwise regulated and defined, terms such as “installation,” “bonded,” and “connection” shall be understood in a broad sense, and for example, may refer to fixed connection or detachable connection or integral connection; may refer to mechanical connection or electrical connection; and may refer to direct connection or indirect connection through an intermediate medium or inner communication of two elements. For those of ordinary skill in the art, the meanings of the above terms in the present disclosure may be understood according to concrete conditions.

In addition, terms such as “first” and “second” are only used for the purpose of description, rather than being understood to indicate or imply relative importance or hint the number of indicated technical features. Thus, the feature limited by “first” and “second” can explicitly or implicitly comprise one or more features. In the description of the present disclosure, the meaning of “a plurality of” is two or more unless otherwise specified.

Unless otherwise defined, all technical and scientific terms used herein have the same meaning as commonly understood by those skilled in the art of the present disclosure. The terms used in the description of the present disclosure herein are only for the purpose of describing specific embodiments, and are not intended to limit the present disclosure. The term “and/or” used in the present disclosure comprises any and all combinations of one or more of the associated listed items.

As people's living standards continue to improve, more and more people are paying attention to their spiritual lives, and keeping pets has become one of ways for many to add fun to their lives. Cats, with their independent personalities and adorable appearance, become a top choice among many pets. While keeping the cats indeed brings companionship and satisfaction to cat owners, it also comes with some daily care hassles, especially cleaning cat feces every day, which causes considerable trouble for many cat owners.

Conventional cat faces cleaning mainly relies on manual operation. Specifically, after a cat defecates in a cat litter box, a cat owner needs to manually scoop and remove the cat feces, which not only requires frequent close contact with the cat feces but also requires enduring the odor.

Currently, automatic cat litter boxes, which use a motor to automatically separate cat litter and the cat feces, appear on the market. The automatic cat litter boxes eliminate a need for manual scooping the cat feces and provide great convenience for the cat owners. However, the automatic cat litter boxes on the market still have some design shortcomings. Specifically, waste collecting compartments are commonly disposed at a bottom portion of the automatic cat litter boxes, resulting in an entrance for the cat to enter and exit the automatic cat litter boxes being relatively high off the ground, which is not user-friendly for smaller cats. In addition, the automatic cat litter boxes commonly have mechanical rolling clamping structures therein, which pose a certain risk of pinching injury and may threaten the safety of the cats.

A cat litter box provided in the embodiments of the present disclosure is described below.

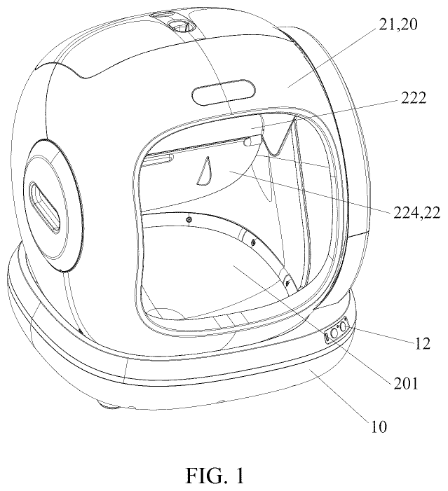

As shown in FIGS. 1-4, the cat litter box comprises a base 10, a driver 13, and a drum assembly 20. The base 10 is placed on the ground to support and stabilize the cat litter box. The drum assembly 20 is installed on the base 10. The base 10 supports the drum assembly 20 and allows the drum assembly 20 to rotate.

The driver 13 is configured to drive the drum assembly 20 to rotate. The driver 13 outputs rotational motion, causing the drum assembly 20 to rotate. A rotation of the drum assembly 20 is generally a self-rotation. That is, a rotation axis of the drum assembly 20 is a central axis of the drum assembly 20. A position of the drum assembly 20 relative to the base is unchanged while rotating, ensuring stability of the cat litter box during rotation.

The drum assembly 20 is disposed on the base 10 and is supported by the base 10. The drum assembly 20 comprises a drum body 21 and a partition assembly 22. The drum body 21 defines an accommodating cavity. The partition assembly 22 divides the accommodating cavity into a first cavity 201 and a second cavity 202.

The first cavity 201 provides a place for the pet to stay. The first cavity 201 provides an area for the pet to urinate and defecate. The first cavity is further configured to accommodate cat litter. After the pet defecates, the cat litter clumps around feces to form a clump. For ease of description and understanding, the clump is referred to as waste. In other words, when the pet needs to defecate, the pet enters the first cavity 201, where the cat litter is located inside and, due to gravity, at a lowest position of the first cavity. The partition assembly 22 divides the accommodating cavity into two independent cavities (i.e., the first cavity and the second cavity), thereby reducing a risk of the cat being pinched.

The second cavity 202 comprises a waste collecting compartment 2022 and a litter collecting compartment 2021 spaced apart from the waste collecting compartment 2022. The waste collecting compartment 2022 is configured to collect the waste and is also configured to collect the cat litter that needs to be replaced. In short, the waste collecting compartment 2022 is configured to collect items to be discarded. The litter collecting compartment 2021 collects the cat litter sieved during each waste collection, and the cat litter is recycled.

The partition assembly 22 comprises a partition plate 222, a little guide plate 223, a litter sieve 221, and an emptying plate 224. The partition plate 222, the little guide plate 223, and the litter sieve 221 jointly divide the accommodating cavity into the first cavity 201 and the second cavity 202. The partition plate 222 is disposed between the little guide plate 223 and the litter sieve 221. The litter sieve 221 has mesh holes, allowing the cat litter to pass through, but preventing the waste from passing through. The litter sieve 221 is configured as a litter inlet of the little collecting compartment. That is, the cat litter is allowed to enter the litter collecting compartment 2021 from the first cavity 201 through the litter sieve 221. The little guide plate 223 is movable relative to the partition plate 222. The little guide plate 223 is configured as a door of a waste inlet 203 of the waste collecting compartment. When the little guide plate 223 moves relative to the partition plate 222, the waste inlet 203 of the waste collecting compartment 2022 is exposed. That is, the first cavity 201 is communicated with the waste collecting compartment 2022, and the waste is then falling into the waste collecting compartment 2022 from the first cavity through the litter guide plate 223. The emptying plate 224 is configured to shield the litter sieve 221, so as to isolate the first cavity 201 and the little collecting compartment 2021. In this way, when the cat litter flows to the emptying plate 224, the cat litter does not fall into the litter collecting compartment 2021.

In an initial state of the cat litter box, part of inner walls of the first cavity 201 is located at the lowest point of the accommodating cavity, and the cat litter is located at the lowest point of the accommodating cavity under gravity. Therefore, the waste collecting compartment 2022 is located on one side of the drum assembly 20, making it convenient for the pet owner to open the waste collecting compartment 2022 and clean up the waste.

When it is necessary to collect the waste, the driver 13 rotates the drum assembly 20 in a first direction, causing the litter sieve 221 to gradually rotate to a horizontal position. The cat litter passes through the litter sieve 221 into the litter collecting compartment 2021, while the waste, due to its larger size, remains on the litter sieve 221. The drum assembly 20 continues to rotate in the first direction, and the litter guide plate 223 moves until the litter guide plate 223 gradually rotates to be roughly horizontal or fully horizontal. The waste pushes open the litter guide plate 223 and enters the waste collecting compartment 2022. Then, the driver 13 rotates the drum assembly 20 in a second direction until the cat litter box returns to the initial state. At this point, the cat litter returns from the litter collecting compartment 2021 back to the first cavity 201 through a draining plate, so that the cat litter is recycled. The second direction is opposite to the first direction. For instance, when the first direction is clockwise, the second direction is counterclockwise.

When it is necessary to replace the cat litter, the emptying plate 224 covers the litter sieve 221. The driver 13 rotates the drum assembly 20 in the first direction, and the litter guide plate 223 moves until the litter guide plate 223 is roughly or horizontally positioned. The cat litter pushes open the litter guide plate 223 and enters the waste collecting compartment 2022. Then, the driver 13 rotates the drum assembly 20 in the second direction until the cat litter box returns to the initial state, allowing the pet owner to add new cat litter into the first cavity 201.

The waste collecting compartment 2022 may be cleaned periodically or after each waste collection, either by replacing a trash bag or by emptying the waste collecting compartment 2022 manually.

In the embodiment, the cat litter box comprises the base 10, the driver 13, and the drum assembly 20. The drum assembly 20 comprises the drum body 21 and the partition assembly 22. The partition assembly 22 divides the accommodating cavity of the drum body 21 into the first cavity 201 and the second cavity 202. The first cavity 201 provides a staying space for the pet, such as the cat, while the second cavity 202 comprises the waste collecting compartment 2022 and the litter collecting compartment 2021 that are spaced apart from each other. The partition assembly 22 comprises the partition plate 222, the litter guide plate 223, the litter sieve 221, and the emptying plate 224. The litter guide plate 223 is configured as the door of the waste inlet 203 of the waste collecting compartment 2022, and the litter sieve 221 is configured as the litter inlet of the litter collecting compartment 2021. In the initial state, part of the inner wall of the first cavity 201 is located at the lowest point of the accommodating cavity, and the cat litter is located at the lowest point under the action of gravity. Therefore, the waste collecting compartment 2022 is located on the side of the drum assembly 20, making it convenient for the pet owner to open the waste collecting compartment 2022 and clean up the feces.

When the pet defecates, the cat litter is placed at the bottom portion of the first cavity 201. After the pet defecates, during a cleaning process, the driver 13 rotates the drum assembly 20 in the first direction. As the litter sieve 221 rotates to approach the bottom of the first cavity 201, the cat litter passes through the litter sieve 221 into the litter collecting compartment 2021, while larger waste remains on the litter sieve 221, thereby separating the cat litter from the waste. After separation, the drum assembly 20 continues to rotate, causing the waste to slide along a surface of the litter sieve 221 and a surface of the partition plate 222 toward the litter guide plate 223. The litter guide plate 223 is then pushed open, allowing the waste to enter the waste collecting compartment 2022. Subsequently, the driver 13 rotates the drum assembly 20 in a second direction to return the partition assembly 22 to an initial position, and the cat litter falls back into the first cavity 201 under gravity. When it is necessary to replace the cat litter, the emptying plate 224 is positioned to cover the litter sieve 221. The driver 13 then rotates the drum assembly 20 in the first direction, causing the cat litter to slide along the surface of the emptying plate 224 and the surface of the partition plate 222 toward the litter guide plate 223. The litter guide plate 223 is pushed open, allowing the cat litter to enter the waste collecting compartment 2022.

In the cat litter box of the present disclosure, when the drum assembly 20 is in the initial position, the waste collecting compartment 2022 is located on one side of the drum assembly 20, thereby reducing a height of the base 10 and making it easier for the pet to enter an interior of the drum assembly 20. Furthermore, the partition assembly 22 divides the accommodating cavity into the first cavity 201 and the second cavity 202, and there is no rolling clamping structure inside the accommodating cavity, which avoids the risk of pinching injury of the pet. Additionally, by providing the emptying plate 224, the cat litter is allowed to be automatically transferred to the waste collecting compartment 2022, eliminating a need for manual replacement of the cat litter.

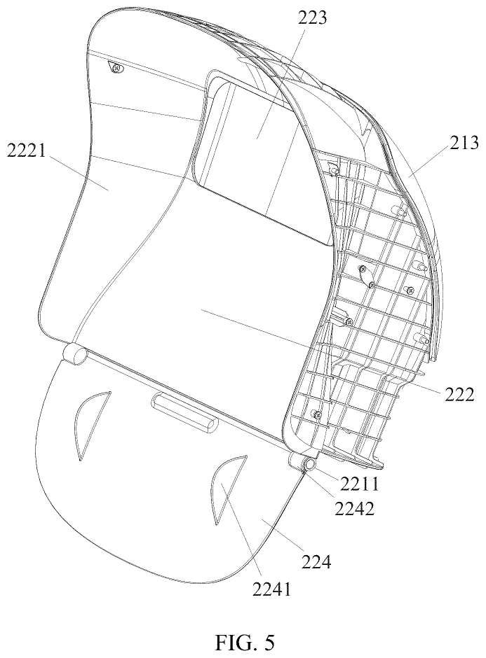

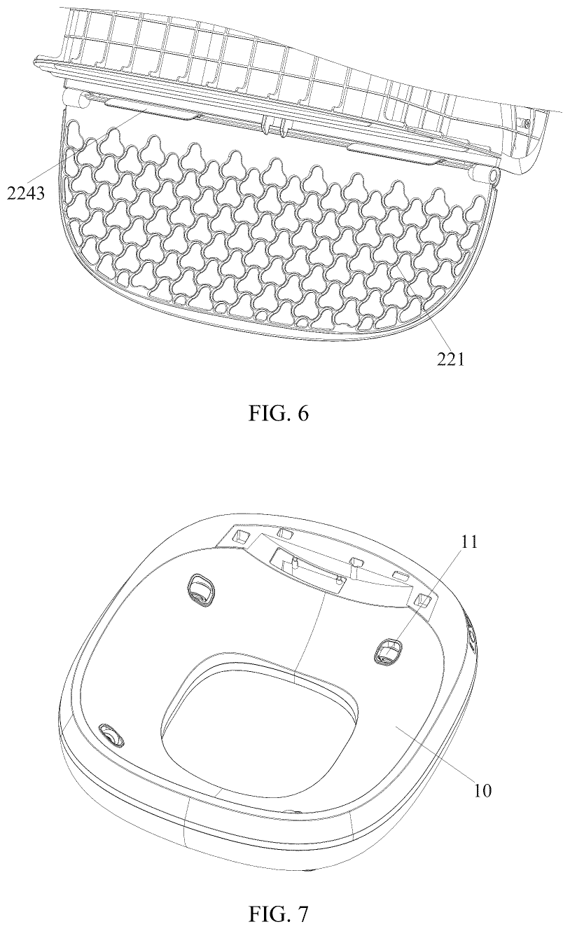

In some embodiments, as shown in FIGS. 5-6, the emptying plate 224 is detachably connected to the litter sieve 221. The pet owner is allowed to either install the emptying plate 224 to the litter sieve 221 or remove the emptying plate 224, depending on different operational requirements.

Specifically, when waste collection is required, that is, when it is necessary to separate the waste from the cat litter, the emptying plate 224 is not installed on the litter sieve 221. The cat litter passes through the litter sieve 221, achieving the separation of the waste and the cat litter. When it is necessary to replace the cat litter, the emptying plate 224 is installed on the litter sieve 221. During the rotation of the drum assembly 20, the cat litter does not pass through the litter sieve 221 into the litter collecting compartment 2021 but is transferred directly into the waste collecting compartment 2022.

In some embodiments, as shown in FIGS. 5-6, first engaging portions are disposed on the litter sieve 221. Second engaging portions are disposed on the emptying plate 224. The first engaging portions are respectively engaged with the second engaging portions. The first engaging portions are recessed structures, protruding structures, or a combination of both. Similarly, the second engaging portions are recessed structures, protruding structures, or a combination of both.

Through mutual cooperation of the first engaging portions and the second engaging portions, the emptying plate 224 is snapped with the litter sieve 221, thereby achieving a detachable connection therebetween. Furthermore, during the installation or removal of the emptying plate 224, no tools are required. That is, the emptying plate 224 is allowed to be installed or detached by hand.

In some embodiments, as shown in FIGS. 5 and 6, one of a group of the first engaging portions and a group of the second engaging portions is rotating shafts 2211, and the other group is shaft holes 2242, so that the emptying plate 224 is rotatable relative to the litter sieve 221. There are two cases for the first engaging portions and the second engaging portions. In a first case, the first engaging portions are the rotating shafts 2211 and the second engaging portions are the shaft holes 2242;. In a second case, the first engaging portions are the shaft holes 2242 and the second engaging portions are the rotating shafts 2211.

When the first engaging portions are engaged with the second engaging portions, the rotating shafts 2211 and the shaft holes 2242 are coaxially disposed, cross-sections of the rotating shafts and cross-sections of the shaft holes 2242 are circular. Therefore, the emptying plate 224 is rotatable relative to the litter sieve 221. In this way, when installing the emptying plate 224, the emptying plate 224 is first positioned at a certain angle relative to the litter sieve 221, with the first engaging portions respectively aligned with the second engaging portions. Then, the hand of the pet owner reaches between the emptying plate 224 and the litter sieve 221, facilitating the application of force to connect the first engaging portions to the second engaging portions. After the first engaging portions are connected to the second engaging portions, the emptying plate 224 is rotated relative to the litter sieve 221 until the emptying plate 224 covers the litter sieve 221. Similarly, when removing the emptying plate 224, the emptying plate 224 is first rotated relative to the litter sieve 221 to create an angle therebetween, making it easier for the pet owner to apply force and disengage the first second engaging portions and the second engaging portions.

Optionally, there are two first engaging portions and two second engaging portions. The two first engaging portions are disposed on an edge of the litter sieve 221 close to the partition plate 222, and the two second engaging portions are disposed on an edge of the emptying plate 224 close to the partition plate 222. Therefore, a connection between the emptying plate 224 and the litter sieve 221 is stable.

Optionally, at least one grip portion 2241 for handling is disposed on one side of the emptying plate 224 facing away from the litter sieve 221. The at least one grip portion 2241 is understood as a protruding structure extending from a surface of the emptying plate 224. The at least one grip portion 2241 is configured to be gripped by the pet owner to facilitate holding, installation or removal of the emptying plate 224 by hand.

The at least one grip portion 2241 is a rib extending from the surface of the emptying plate 224. The at least one grip portion 224 comprises one or more grip portions 224, and the number and positions of the at least one grip portion 224 are not limited thereto.

In some embodiments, as shown in FIG. 6, at least one hooking portion 2243 is disposed on one side of the emptying plate 224 close to the partition plate 222. When the emptying plate 224 is installed on the litter sieve 221, the at least one hooking portion 2243 is inserted between the partition plate 222 and the litter sieve 221.

In the embodiment, by providing the at least one hooking portion 2243 on the emptying plate 224, the emptying plate 224 is easily installed to the litter sieve 221. During installation, the at least one hooking portion 2243 is simply hooked onto the litter sieve 221, making both attachment and removal effortless.

In some embodiments, the at least one hooking portion 2243 is a sheet, which is easily inserted between the litter sieve 221 and the partition plate 222.

In some embodiments, the at least one hooking portion 2243 comprises a plurality of hooking portions 2243. The plurality of hooking portions 2243 are disposed sequentially along a length direction of a gap between the partition plate 222 and the litter sieve 221.

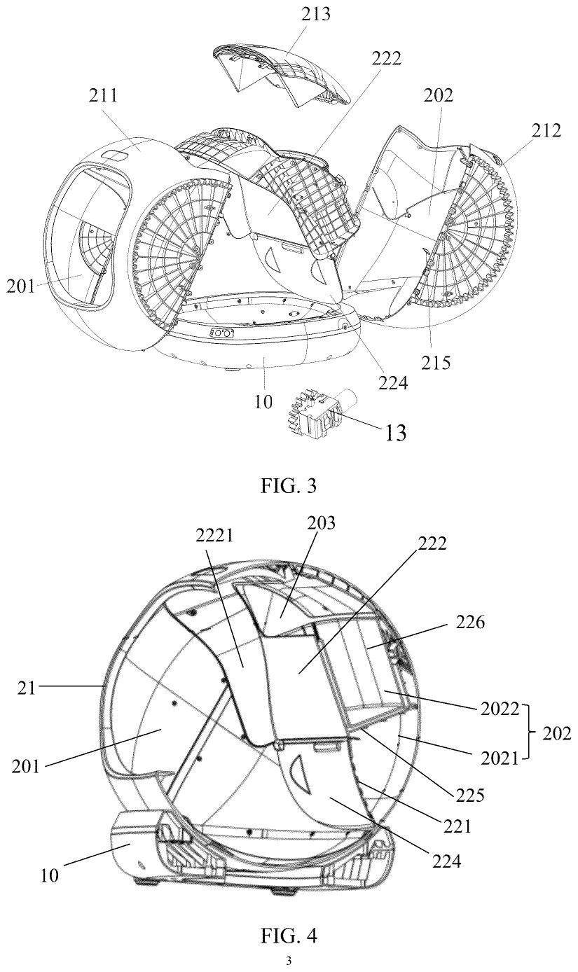

In some embodiments, as shown in FIGS. 3, 5, and 6, one side of the litter sieve 221 close to the partition plate 222 is rotatably connected to the partition plate 222. A stop portion 215 is disposed on one side of the drum body 21 where the litter sieve 221 faces the litter collecting compartment 2021. When the cat litter box is in the initial state, the litter guide plate 223, the partition plate 222, and the litter sieve 221 are disposed from top to bottom. One side of the litter sieve 221 close to the partition plate 222 is a top side of the litter sieve 221. That is, the top side of the litter sieve 221 is pivotally connected to the partition plate 222. Meanwhile, the stop portion 215 is disposed on the inner wall of the drum body 21. The stop portion 215 is configured to stop the litter sieve 221, thereby limiting a rotation of the litter sieve 221. Since the stop portion 215 is disposed on one side of the litter sieve 221 facing the litter collecting compartment 2021, the stop portion 215 serves to block any movement of the litter sieve 221 toward the interior of the litter collecting compartment 2021. Namely, the litter sieve 221 is only allowed to rotate in a direction away from the litter collecting compartment 2021.

In the embodiment, the litter sieve 221 is rotatably connected with the partition plate 222, and the stop portion 215 is disposed on the drum body 21, so that the litter sieve 221 is only allowed to rotate in a direction away from the litter collecting compartment 2021. In this way, it ensures that during waste collection, the litter sieve 221 remains stably positioned at an edge of the litter collecting compartment 2021, so that litter sieving and waste collection are not affected. After waste collection, the litter sieve 221 is manually rotated to open the litter collecting compartment 2021, allowing the cat litter to quickly fall back into the first cavity 201, preventing excessive cat litter residue from remaining in the litter collecting compartment 2021.

In some embodiments, as shown in FIG. 5, one side of the litter guide plate 223 away from the partition plate 222 is rotatably connected to the drum body 21. When the cat litter box is in the initial state, the litter guide plate 223, the partition plate 222, and the litter sieve 221 are disposed from top to bottom. The one side of the litter guide plate 223 away from the partition plate 222 is a top side of the litter guide plate 223. In other words, a top portion of the litter guide plate 223 is rotatably connected to the drum body 21. In this way, when the waste moves to the litter guide plate 223, the waste directly pushes against the one side of the litter guide plate 223 close to the partition plate 222, so that the waste rapidly enters the waste collecting compartment 2022.

In some embodiments, as shown in FIGS. 5-6, one side of the litter sieve 221 facing the first cavity 201, one side of the partition plate 222 facing the first cavity 201, and one side of the litter guide plate 223 facing the first cavity 201 are smoothly transitioned and jointly form a first surface. The first surface is one of the inner walls of the first cavity 201, while remaining inner walls of the first cavity 201 are part of the inner walls of the drum body 21.

By making the first surface smooth, part of the inner walls of the first cavity 201 is smooth. Furthermore, the remaining inner walls of the first cavity 201 (part of the inner walls of the drum body 21) are typically smooth. In this way, when the pet is inside the first cavity 201, the pet is not pinched or scratched by the inner walls of the first cavity 201, thereby protecting the pet.

In some embodiments, the one side of the litter sieve 221 facing the first cavity 201, the one side of the partition plate 222 facing the first cavity 201, and one side of the litter guide plate 223 facing the first cavity 201 are are flat surfaces or curved surfaces, as long as they are smoothly transitioned.

In some embodiments, as shown in FIGS. 3 and 4, the drum assembly 20 further comprises a waste bin 226. An interior of the waste bin 226 is the waste collecting compartment 2022. The waste bin 226 may be used by attaching the trash bag or may be used directly. A waste chamber is enclosed by one side of the partition plate 222 facing the waste bin 226 and one side of the drum body 21 facing the waste bin 226. The waste bin 226 is placed inside this waste chamber and is allowed to be removed from the waste chamber, making it convenient for the pet owner to clean the waste.

In some embodiments, the drum assembly 20 further comprises a dividing plate 225 disposed in the second cavity 202. The dividing plate 225 divides the second cavity 202 into the waste collecting compartment 2022 and the litter collecting compartment 2021. In other words, the dividing plate 225 divides the second cavity 202 into the waste chamber and the litter collecting compartment 2021. A first side of the dividing plate 225 is connected to the partition plate 222, a second side of the dividing plate 225 (opposite to the first side of the dividing plate) extends to the inner walls of the drum body 21.

Optionally, the dividing plate 225 is integrally formed with the partition plate 222, which reduces the number of parts of the drum assembly 20, simplifies the installation of the drum assembly 20, and streamlines an internal structural layout of the drum assembly 20.

In some embodiments, a gap between the drum body 21 and the base 10 is less than 5 mm, such as, 4 mm or 3 mm. The gap between the drum body 21 and the base 10 is understood as a minimum clearance between the drum body 21 and the base 10. If the gap is too large, there is a risk that pet hair or limbs could easily get caught between the drum body 21 and the base 10, posing the risk of hurting the pet. By setting the gap between the drum body 21 and the base 10 to less than 5 mm, the risk of the cat being pinched is avoided.

In some embodiments, as shown in FIG. 1, a gravity sensor 12 configured to detect a weight change of the drum assembly 20 is disposed on the base 10. The weight change of the drum assembly 20 does not refer to a change in a weight of the drum assembly itself, but rather to a change in a total weight of the drum assembly 20 and items placed therein. For example, a change in a weight of the cat litter may cause a change in the weight of the drum assembly 20, and a presence or absence of the pet inside the drum assembly 20 also cause the change in the weight of the drum assembly 20.

In the embodiment, by providing the gravity sensor 12, it is detected whether the pet enters the drum assembly 20. When the pet is detected, the drum assembly 20 is stopped to prevent the cat from being pinched.

In some embodiments, edges and corners of the drum body 21 are chamferred, ensuring that surfaces of the drum body 21 are smooth to prevent the cat from being pinched.

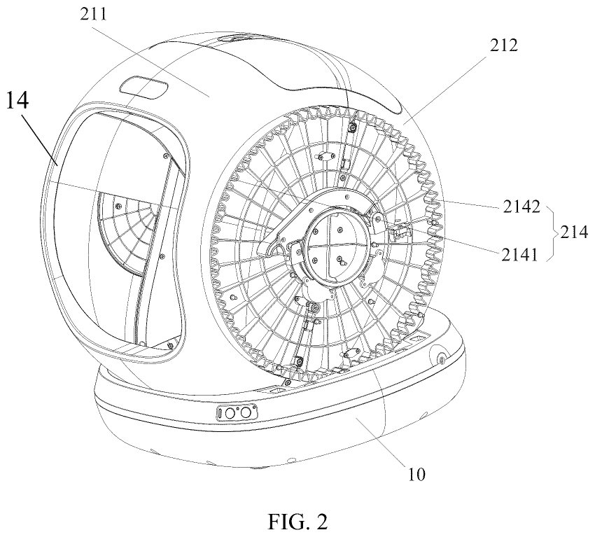

In some embodiments, as shown in FIGS. 2-4, the drum body 21 comprises a first drum section 211, a second drum section 212, and a cover 213. The first drum section 211 has a pet entrance for the pet to enter. The cover 213 covers an outlet of the waste collecting compartment 2022. The partition plate 222 extends along an inner wall of the first drum section 211 and/or an inner wall of the second drum section 212 to form an extension portion 2221. The extension portion 2221 is fixed to the first drum section 211 and/or the second drum section 212. The first drum section 211, the second drum section 212, and the cover 213 jointly enclose the drum body 21 and define the accommodating cavity. When the pet needs to defecate, the pet enters the first cavity 201 through the pet entrance 14 defined on the first drum section 211. When it is necessary to clean the waste collecting compartment 2022, the cover 213 is opened to expose the waste collecting compartment, facilitating the cleaning of collected waste. The extension portion 2221 is integrally formed with the partition plate 222. The extension portion 2221 is fixed to the inner wall of the first drum section 211 and/or the inner wall of the second drum section 212. By fixing the extension portion, the partition plate 222 is fixed in place, which facilitates an installation of the partition plate 222.

In an initial state, the pet entrance 14 is located at a bottom portion of the drum body, and a plane where a geometric center of the pet entrance 14 lies is parallel to a rotation axis of the drum body.

In the embodiment, the drum body 21 is composed of the first drum section 211, the second drum section 212 and the cover 213, so that the drum body 21 is easy to manufacture and an installation of the partition assembly 22 is also easy. The extension portion 2221 allows the partition assembly 22 to fit snugly against inner walls of the drum body 21, further reducing the risk of the cat being pinched, and makes it easy to install the partition assembly 22 on the inner wall of the drum body 21.

In some embodiments, the extension portion 2221 fits against the inner wall of the drum body 21, making it easier for the extension portion 2221 to be fixed to the drum body. Specifically, the extension portion 2221 may fit against the inner wall of the first drum section 211, or the extension portion 2221 may fit against the inner wall of the second drum section 212, or the extension portion 2221 may fit against the inner wall of the first drum section 211 and the inner wall of the second drum section 212.

In some embodiments, as shown in FIGS. 2 and 3, a first toothed portion 2141 is disposed on one side of the first drum section 211, A second toothed portion 2142 is disposed on one side of the second drum section 212. The first toothed portion 2141 and the second toothed portion 2142 form an annular toothed structure 214. This toothed structure 214 is engaged with a component, such as a gear component, to control the rotation of the drum assembly 20. The first toothed portion 2141 and the second toothed portion 2142 are shaped as non-enclosed semi-circular arcs. After the first drum section 211 and the second drum section 212 are connected, the first drum section 211 and the second drum section 212 jointly form the annular toothed structure 214, enabling proper engagement and transmission.

By configuring the annular toothed structure 214 as separate parts (i.e., the first toothed portion 2141 and the second toothed portion 2142), the machining difficulty is reduced, thereby reducing manufacturing costs.

In some embodiments, the annular toothed structure 214 formed by the first toothed portion 2141 and the second toothed portion 2142 is disposed on an outer side surface of the drum body 21 and is configured as an outer toothed structure 214 configured to engage with the gear component for transmission.

In other embodiments, the annular toothed structure 214 is just disposed on one side of the first drum section 211 or is just disposed on one side of the second drum section 212.

In some embodiments, the cat litter box further comprises a drive gear rotated by the driver 13. The drive gear is engaged with the toothed structure 214 for transmission. Thus, the driver 13 is able to rotate the drive gear, which in turn drives the annular toothed structure 214 to rotate, thereby causing the drum assembly 20 to rotate.

In some embodiments, the driver 13 is a motor or an engine.

In some embodiments, the driver 13 and the drive gear are disposed inside the base 10.

In some embodiments, as shown in FIG. 7, roller assemblies 11 are disposed on one side of the base 10 facing the drum assembly 20. The roller assemblies 11 are configured to support the drum assembly 20. It is understood that the roller assemblies 11 are disposed on a top surface of the base 10. The roller assemblies 11 support the drum assembly 20, and rotation axes of the roller assemblies 11 are parallel to the rotation axis of the drum assembly 20. They roller assemblies 11 provide rotational guidance and reduce friction between the base 10 and the drum assembly 20.

In the embodiment, by providing the roller assemblies 11 on the base 10, the drum assembly 20 is supported, the rotation of the drum assembly 20 is guided, and the friction between the base 10 and the drum assembly 20 reduces. In this way, bearings are eliminated to reduce the manufacturing cost of the cat litter box.

In some embodiments, there are four roller assemblies 11. The four roller assemblies 11 are respectively disposed on four corners of the base 10, so that the drum body are stably supported.

The above description is merely optional embodiments of the present disclosure and is not intended to limit the present disclosure. Any modifications, equivalent substitutions, and improvements made within the spirit and principles of the present disclosure should be comprised within the protection scope of the present disclosure.

What is claimed is:

1. A cat litter box, comprising:
a base;
a driver; and
a drum assembly;
wherein the drum assembly is rotatably disposed on the base and is driven to rotate by the driver, the drum assembly comprises a drum body defining an accommodating cavity and a partition assembly disposed in the drum body;
wherein a pet entrance is defined on on a circumferential surface of the drum body;
wherein the partition assembly comprises a partition plate, a little guide plate, a litter sieve, and an emptying plate;
wherein the partition plate is disposed between the little guide plate and the litter sieve, and the partition plate, the little guide plate, and the litter sieve jointly divide the accommodating cavity into a first cavity and a second cavity;
wherein the first cavity is communicated with the pet entrance and is configured for a pet to stay, a waste collecting compartment and a little collecting compartment are defined in the second cavity, and the waste collecting compartment and the little collecting compartment are spaced apart from each other;
wherein the litter sieve is configured as a litter inlet of the little collecting compartment, and the little guide plate is movable relative to the partition plate to communicate the first cavity and the waste collecting compartment;
wherein the little guide plate is a door of a waste inlet of the waste collecting compartment, and the emptying plate is configured to cover the litter sieve so as to isolate the first cavity and the little collecting compartment.

2. The cat litter box according to claim 1, wherein the emptying plate is detachably connected to the litter sieve.

3. The cat litter box according to claim 2, wherein at least one hooking portion is disposed on one side of the emptying plate close to the partition plate, and the at least one hooking portion is configured to insert between the partition plate and the litter sieve.

4. The cat litter box according to claim 2, wherein at least one hooking portion comprises hooking portions, the hooking portions are in a sheet shape and are arranged along a length direction of the partition plate, and the hooking portions are configured to hook on the litter sieve to connect the emptying plate to the litter sieve.

5. The cat litter box according to claim 2, wherein at least one first engaging portion is disposed on the litter sieve, at least one second engaging portion is disposed on the emptying plate, and the at least one first engaging portion is engaged with the at least one second engaging portion.

6. The cat litter box according to claim 5, wherein the at least one first engaging portion is a rotating shaft, and the at least one second engaging portion is a shaft hole; or
the at least one first engaging portion is the shaft hole, and the at least one second engaging portion is the rotating shaft.

7. The cat litter box according to claim 1, wherein one side of the litter sieve close to the partition plate is rotatably connected to the partition plate, and a stop portion is disposed on one side of the drum body where the litter sieve faces the litter collecting compartment.

8. The cat litter box according to claim 1, wherein a gap between the drum body and the base is less than 5 mm.

9. The cat litter box according to claim 1, wherein a gravity sensor configured to detect a weight change of the drum assembly is disposed on the base.

10. The cat litter box according to claim 1, wherein the drum body comprises a first drum section, a second drum section, and a cover;
wherein the first drum section has the pet entrance for the pet to enter, the cover covers an outlet of the waste collecting compartment, the partition plate extends along an inner wall of the first drum section and/or an inner wall of the second drum section to form an extension portion, and the extension portion is fixed to the first drum section and/or the second drum section.

11. The cat litter box according to claim 10, wherein a first toothed portion is disposed on one side of the first drum section, a second toothed portion is disposed on one side of the second drum section, and the first toothed portion and the second toothed portion jointly form an annular toothed structure.

12. The cat litter box according to claim 1, wherein roller assemblies configured to support the drum assembly are disposed on one side of the base facing the drum assembly.

13. The cat litter box according to claim 1, wherein at least one grip portion for handling is disposed on one side of the emptying plate facing away from the litter sieve, the at least one grip portion is a rib extending from a surface of the emptying plate.

14. The cat litter box according to claim 1, wherein one side of the litter sieve facing the first cavity, one side of the partition plate facing the first cavity, and one side of the litter guide plate facing the first cavity jointly from a smooth surface, the smooth surface is smoothly transitioned and is an inner wall of the first cavity.

15. The cat litter box according to claim 1, wherein the drum assembly further comprises a waste bin, an interior of the waste bin is defined as the waste collecting compartment, a waste chamber is enclosed by one side of the partition plate facing the waste bin and one side of the drum body facing the waste bin, and the waste bin is removably disposed in the waste chamber.

16. The cat litter box according to claim 1, wherein the drum assembly further comprises a dividing plate disposed in the second cavity, the dividing plate and the partition plate are integrally formed, and the dividing plate divides the second cavity into the waste collecting compartment and a litter collecting compartment.

17. The cat litter box according to claim 1, wherein in an initial state, the pet entrance is located at a bottom portion of the drum body, and a plane where a geometric center of the pet entrance lies is parallel to a rotation axis of the drum body.
